(19) United States
(12) Patent Application Publication
(10) Pub. No.: US 2025/0046970 A1
(43) Pub. Date: Feb. 6, 2025

(54) ELECTRONIC DEVICE INCLUDING BATTERY RESET STRUCTURE

(71) Applicant: SAMSUNG ELECTRONICS CO., LTD., Suwon-si (KR)

(72) Inventors: Junwang KIM, Suwon-si (KR); Kiwon KIM, Suwon-si (KR)

(21) Appl. No.: 18/905,389

(22) Filed: Oct. 3, 2024

Related U.S. Application Data
(63) Continuation of application No. PCT/KR2024/011211, filed on Jul. 31, 2024.

(30) Foreign Application Priority Data
Jul. 31, 2023 (KR) 10-2023-0099828
Aug. 30, 2023 (KR) 10-2023-0114391

(51) Int. Cl. H01M 50/574; H01M 50/247; H01M 50/287

(52) U.S. Cl. CPC H01M 50/574; H01M 50/287; H01M 50/247

(57) ABSTRACT

An electronic device is provided which includes a printed circuit board including an opening. The electronic device may include a switch circuit unit disposed on the printed circuit board and including an input portion to which a power signal of a battery is applied, an output portion from which the switch circuit unit is configured to output the power signal, and a first ground. The electronic device may include a control circuit unit disposed on the printed circuit board. The control circuit unit is configured to control a connection between the input portion and the output portion, and includes a contact terminal. The electronic device may include a positive terminal connected to the printed circuit board to transmit the power signal of the battery. The electronic device may include a negative terminal including a body portion, a control pin formed on the body portion, and a negative electrode contact portion.

This application is a continuation application, claiming priority under § 365 (c), of International Application No. PCT/KR2024/011211, filed on Jul. 31, 2024, which is based on and claims the benefit of Korean Patent Application No. 10-2023-0099828, filed on Jul. 31, 2023, and Korean Patent Application No. 10-2023-0114391, filed on Aug. 30, 2023, the disclosures of which are incorporated by reference herein in their entireties.

### BACKGROUND

### Technical Field

Various embodiments of the disclosure relate to an electronic device including a battery reset structure.

### Description of Related Art

Electronic devices such as, for example, a smartphone, a tablet personal computer (PC), a portable multimedia player (PMP), a personal digital assistant (PDA), a laptop personal computer (PC), and a wearable device, such as a wrist watch and a head-mounted display (HMD), may include a battery to secure portability.

An electronic device may employ a replaceable detachable battery in consideration of unit cost.

The above information is presented as related art to assist with an understanding of the disclosure. No determination has been made, and no assertion is made, as to whether any of the above may be applicable as prior art with regard to the disclosure.

### SUMMARY

In some electronic devices, a replaceable detachable battery may be used instead of an integrated battery that is charged and reused, based on the type of electronic device. For example, an electronic device having low power consumption may employ a detachable battery in consideration of a unit cost.

In an electronic device having low power consumption, even for cases in which the battery is detached, it may take a certain amount of time for the electronic device to consume remaining power existing in an internal circuit of the electronic device. In this case, even though the battery is detached, the remaining power in the internal circuit may cause malfunction of the electronic device. For example, in some cases in which the battery is detached, the electronic device may erroneously detect that the battery is mounted due to the remaining power, and the electronic device may thus perform an abnormal operation, for example, communication with an external electronic device. It is to be understood that, in some cases, descriptions herein of detaching a battery from an electronic device may include blocking an electrical connection between the battery and one or more components of the electronic device, with or without removing the battery from the electronic device. It is to be understood that, in some cases, descriptions herein of mounting a battery in or to an electronic device may include establishing an electrical connection between the battery and one or more components of the electronic device, in association with installing the battery at the electronic device.

Further, in an example in which a new battery is mounted in the electronic device before the remaining power remaining in an internal circuit of the electronic device is entirely used up after the battery is detached, it may take a certain amount of time for the electronic device to detect or recognize that the new battery is mounted. In this case, for the certain amount of time, the electronic device may fail to detect that the new battery is mounted and fail to recognize that the electronic device is in a low power state.

Technical aspects to be achieved in the disclosure are not limited to the technical aspects mentioned herein, and other technical aspects not mentioned will be clearly understood by those skilled in the art from the following description.

An electronic device according to an embodiment of the disclosure includes a printed circuit board including an opening. Further, the electronic device includes a switch circuit unit disposed on the printed circuit board and including an input portion to which a power signal of a battery is applied, an output portion from which the switch circuit unit is configured to output the power signal, and a first ground. Further, the electronic device includes a control circuit unit disposed on the printed circuit board, wherein the control circuit unit is configured to control a connection between the input portion and the output portion, and includes a contact terminal. Further, the electronic device includes a positive terminal connected to the printed circuit board to transmit the power signal of the battery. Further, the electronic device includes a negative terminal including a body portion which faces the contact terminal of the control circuit unit, a control pin formed on the body portion, and a negative electrode contact portion which is at least partly located in the opening and configured to contact a negative electrode of the battery, wherein the negative electrode contact portion is connected to a second ground G2 of the printed circuit board.

A battery structure according to an embodiment of the disclosure includes a printed circuit board including an opening. Further, the battery structure includes a switch circuit unit disposed on the printed circuit board and including an input portion to which a power signal of a battery is applied, an output portion from which the switch circuit unit is configured to output the power signal, and a first ground. Further, the battery structure includes a control circuit unit disposed on the printed circuit board, wherein the control circuit unit is configured to control a connection between the input portion and the output portion, and includes a contact terminal. Further, the battery structure includes a positive terminal connected to the printed circuit board to transmit the power signal of the battery. Further, the battery structure includes a negative terminal including a body portion which faces the contact terminal of the control circuit unit, a control pin formed on the body portion, and a negative electrode contact portion which is at least partly located in the opening and configured to contact a negative electrode of the battery, wherein the negative electrode contact portion is connected to a second ground G2 of the printed circuit board.

A circuit structure according to an embodiment of the disclosure may be connected to a printed circuit board including an opening. Further, the circuit structure includes a switch circuit unit disposed on the printed circuit board and including an input portion to which a power signal of a battery is applied, an output portion from which the switch circuit unit is configured to output the power signal, and a first ground. Further, the circuit structure includes a control circuit unit disposed on the printed circuit board, wherein the control circuit unit is configured to control a connection between the input portion and the output portion, and includes a contact terminal. Further, the circuit structure includes a positive terminal connected to the printed circuit board to transmit the power signal of the battery. Further, the circuit structure includes a negative terminal including a body portion which faces the contact terminal of the control circuit unit, a control pin formed on the body portion, and a negative electrode contact portion which is at least partly located in the opening and configured to contact a negative electrode of the battery, wherein the negative electrode contact portion is connected to a second ground G2 of the printed circuit board.

A battery power reset structure according to an embodiment of the disclosure includes a printed circuit board including an opening. Further, the battery power reset structure includes a switch circuit unit disposed on the printed circuit board and including an input portion to which a power signal of a battery is applied, an output portion from which the switch circuit unit is configured to output the power signal, and a first ground. Further, the battery power reset structure includes a control circuit unit disposed on the printed circuit board, wherein the control circuit unit is configured to control a connection between the input portion and the output portion, and includes a contact terminal. Further, the battery power reset structure includes a positive terminal connected to the printed circuit board to transmit the power signal of the battery. Further, the battery power reset structure includes a negative terminal including a body portion which faces the contact terminal of the control circuit unit, a control pin formed on the body portion, and a negative electrode contact portion which is at least partly located in the opening and configured to contact a negative electrode of the battery, wherein the negative electrode contact portion is connected to a second ground G2 of the printed circuit board.

According to an embodiment of the disclosure, provided is a structure which may immediately consume remaining power of an electronic device when a battery is detached. For example, based on detection of a voltage value of a certain level or less in a control circuit unit connected to a switch circuit unit that supplies or blocks power of the battery, the switch circuit unit and a ground may be connected. Accordingly, in an example in which the battery is detached, the electronic device may be powered off, thus not performing an unintended operation.

Effects obtainable from the disclosure are not limited to the effects mentioned herein, and other effects not mentioned will be clearly understood by those skilled in the art from the following description.

### BRIEF DESCRIPTION OF THE DRAWINGS

In describing the drawings, the same or like reference numerals may be used to refer to the same or like elements.

FIG. 1 is a block diagram of an electronic device in a network environment according to an embodiment of the disclosure;

FIG. 2 is a block diagram of a power management module and a battery according to an embodiment of the disclosure;

FIG. 3A is a lateral view of a battery connected to a printed circuit board through a positive terminal and a negative terminal according to an embodiment of the disclosure;

FIG. 3B is a rear perspective view of a battery connected to a printed circuit board through a positive terminal and a negative terminal according to an embodiment of the disclosure;

FIG. 4 is an assembly view of a printed circuit board, a negative terminal, and a buffer member according to an embodiment of the disclosure;

FIG. 5A is a perspective view of a negative terminal according to an embodiment of the disclosure;

FIG. 5B is a view illustrating a state in which a negative terminal and a buffer member are assembled according to an embodiment of the disclosure;

FIG. 6A is a view illustrating a state in which a control pin is spaced apart from a contact terminal of a control circuit unit of a printed circuit board as a negative electrode contact portion of a negative terminal comes in contact with a negative electrode of a battery in a state in which the battery is mounted in an electronic device according to an embodiment of the disclosure;

FIG. 6B is a simplified view illustrating a circuit connection of the battery and the printed circuit board of FIG. 6A;

FIG. 7A is a view illustrating a state in which a control pin of a negative terminal is in contact with a contact terminal of a control circuit unit of a printed circuit board in a state in which a battery is detached from an electronic device according to an embodiment of the disclosure;

FIG. 7B is a simplified view illustrating a circuit connection of the battery and the printed circuit board of FIG. 7A;

FIG. 8 is a view illustrating a circuit configuration for supplying battery power to an electronic device according to an embodiment of the disclosure;

FIG. 9 is a view illustrating a circuit configuration of a switch circuit unit according to an embodiment of the disclosure; and

FIG. 10 is a view illustrating voltage changes of an electronic device when a battery is detached or mounted according to an embodiment of the disclosure.

### DETAILED DESCRIPTION

It should be appreciated that various embodiments of the present disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the description means that the element may be coupled with the other element directly (e.g., wiredly), wirelessly, or via a third element.

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within +30%, 20%, 10%, 5% of the stated value, for example.

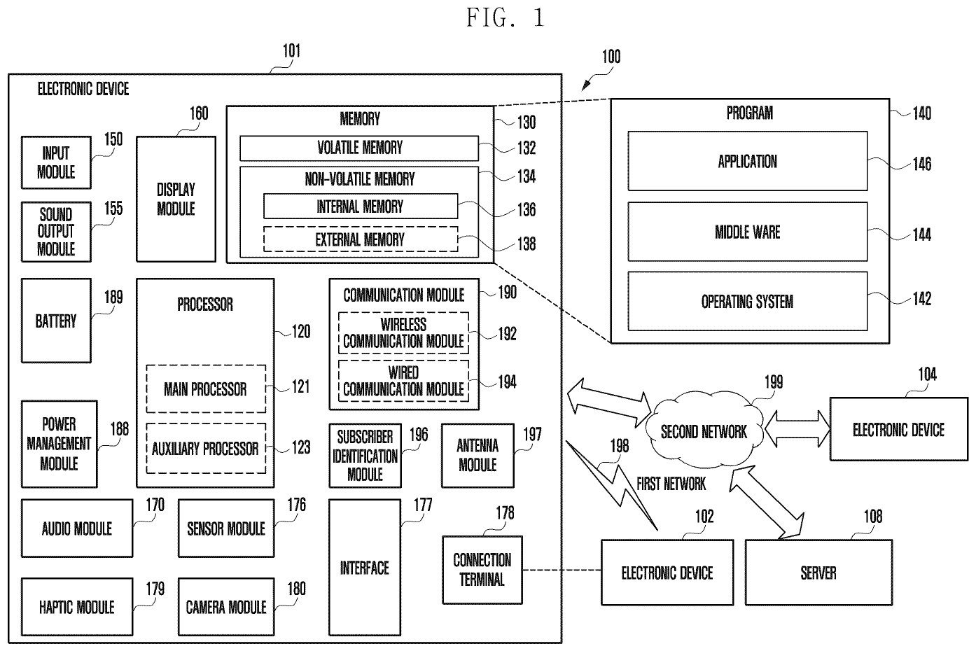

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, in an example in which the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as, for example, Bluetooth™, wireless-fidelity (Wi-Fi) direct, or infrared data association (IrDA)) or the second network 199 (e.g., a long-range communication network, such as, for example, a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as, for example, the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as, for example, the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

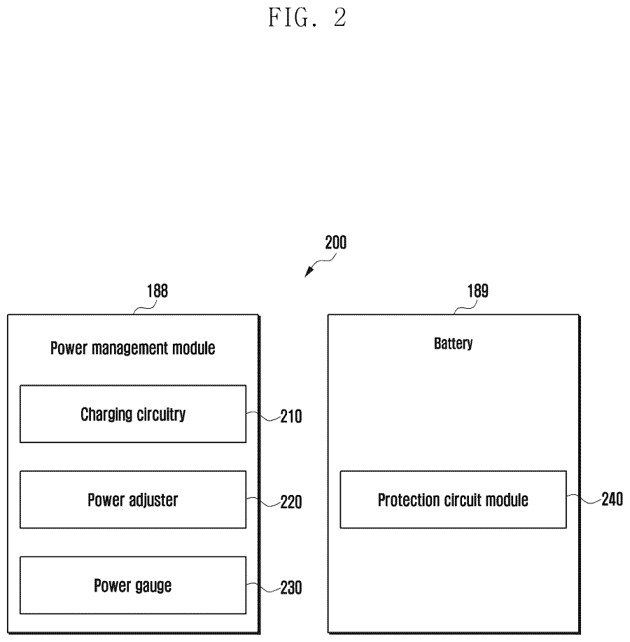

FIG. 2 is a block diagram 200 illustrating the power management module 188 and the battery 189 of electronic device 101 according to various embodiments. Referring to FIG. 2, the power management module 188 may include charging circuitry 210, a power adjuster 220, or a power gauge 230. The charging circuitry 210 may charge the battery 189 by using power supplied from an external power source outside the electronic device 101. According to an embodiment, the charging circuitry 210 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 189, and may charge the battery 189 using the selected charging scheme. The external power source may be connected with the electronic device 101, for example, directly via the connecting terminal 178 or wirelessly via the antenna module 197.

The power adjuster 220 may generate a plurality of powers having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment, the power adjuster 220 may be implemented in the form of a low drop out (LDO) regulator or a switching regulator. The power gauge 230 may measure use state information about the battery 189 (e.g., a capacity, a number of times of charging or discharging, a voltage, or a temperature of the battery 189).

The power management module 188 may determine, using, for example, the charging circuitry 210, the power adjuster 220, or the power gauge 230, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment, at least some of the functions of the power management module 188 may be performed by an external control device (e.g., the processor 120).

The battery 189, according to an embodiment, may include a protection circuit module (PCM) 240. The PCM 240 may perform one or more of various functions (e.g., a pre-cutoff function) to prevent a performance deterioration of, or a damage to, the battery 189. The PCM 240, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment, at least part of the charging state information or use state information regarding the battery 189 may be measured using a corresponding sensor (e.g., a temperature sensor) of the sensor module 176, the power gauge 230, or the power management module 188 . . . . According to an embodiment, the corresponding sensor (e.g., a temperature sensor) of the sensor module 176 may be included as part of the PCM 240, or may be disposed near the battery 189 as a separate device.

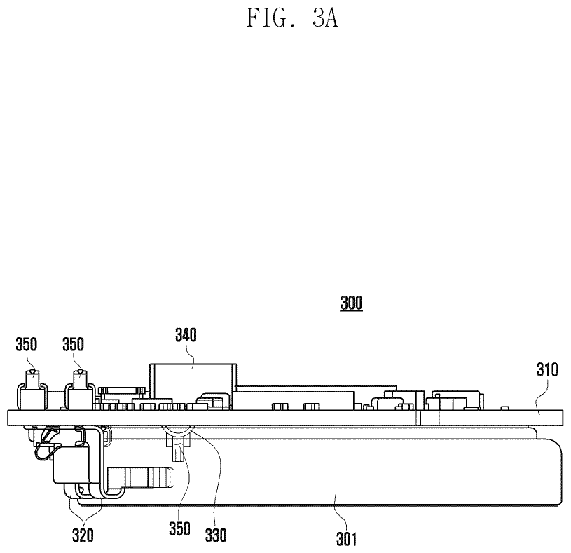

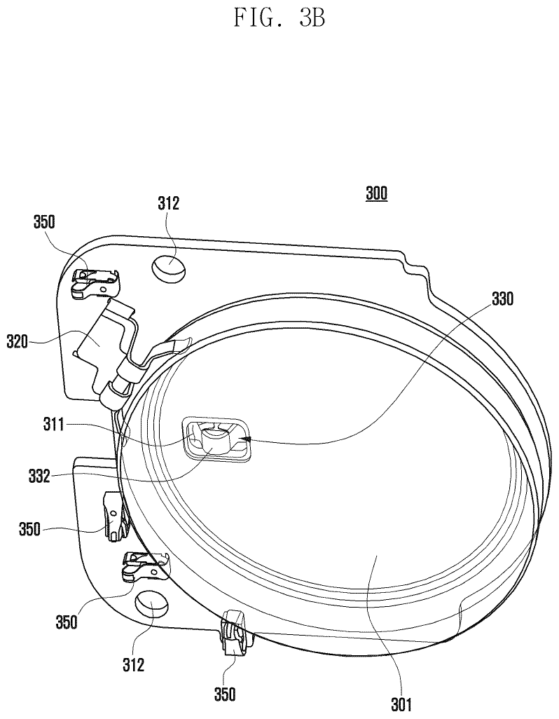

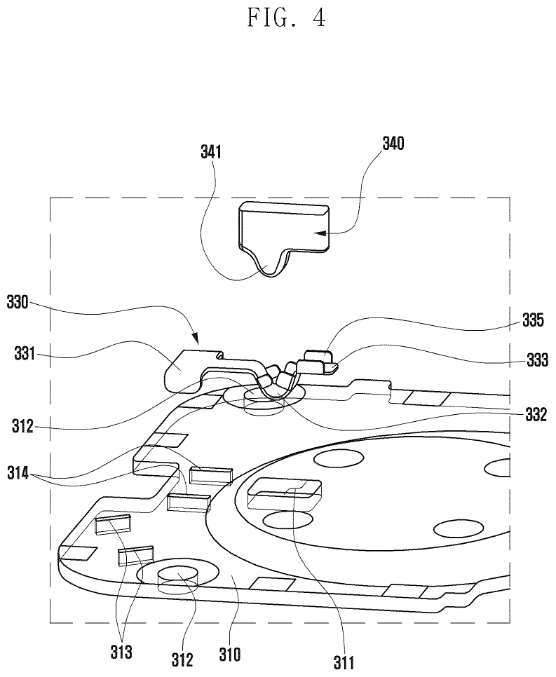

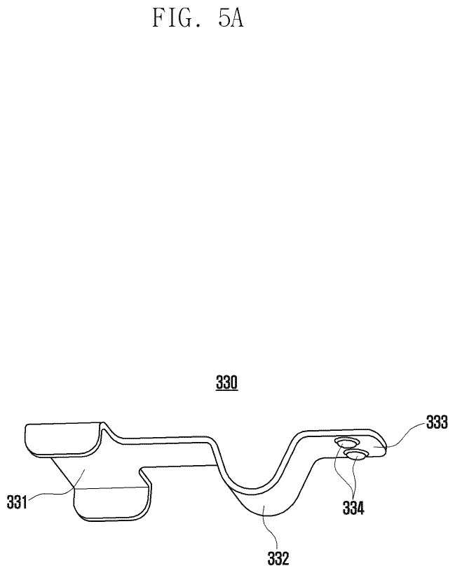

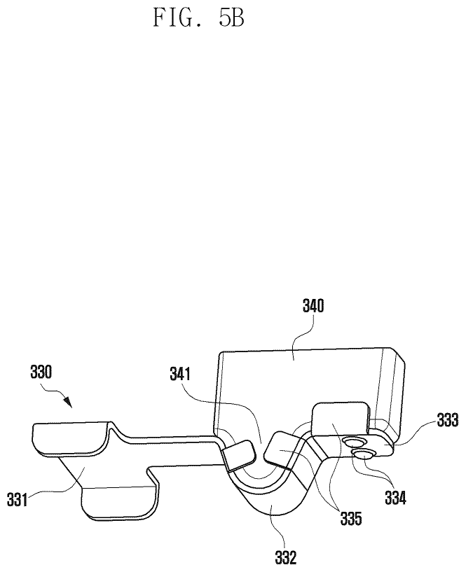

FIG. 3A is a lateral view of a battery connected to a printed circuit board through a positive terminal and a negative terminal according to an embodiment of the disclosure. FIG. 3B is a rear perspective view of a battery connected to a printed circuit board through a positive terminal and a negative terminal according to an embodiment of the disclosure. FIG. 4 is an assembly view of a printed circuit board, a negative terminal, and a buffering member according to an embodiment of the disclosure. FIG. 5A is a perspective view of a negative terminal according to an embodiment of the disclosure. FIG. 5B is a view illustrating a state in which a negative terminal and a buffering member are assembled according to an embodiment of the disclosure.

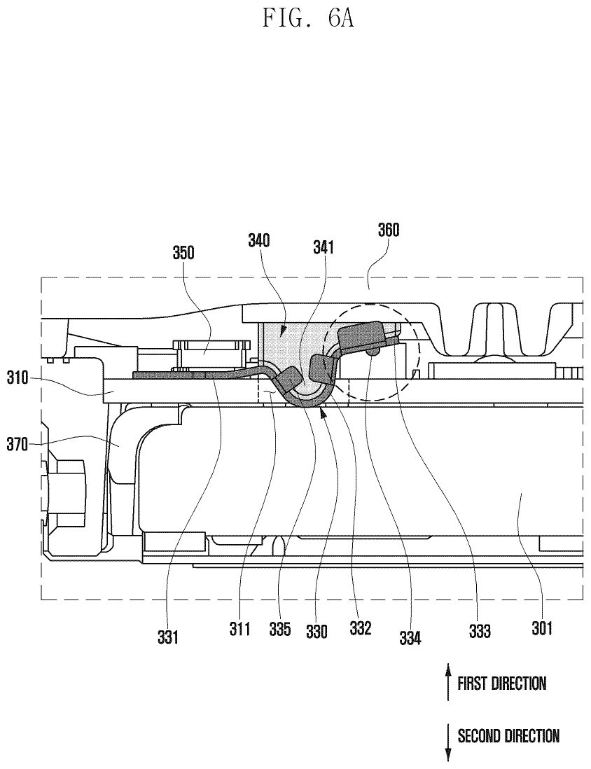

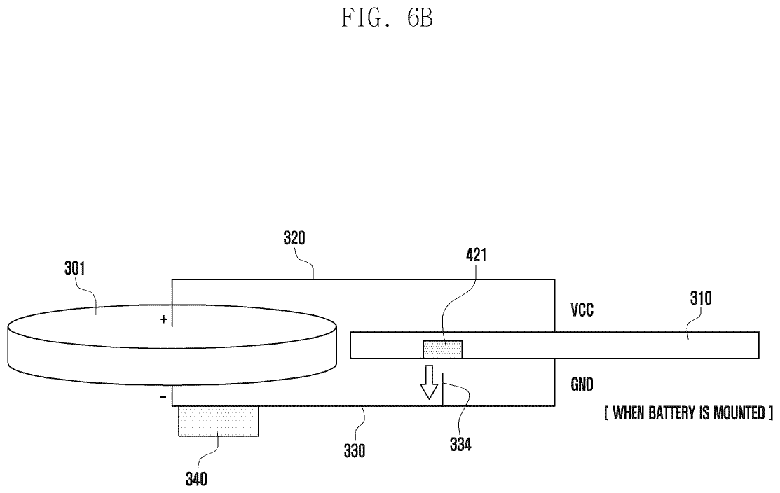

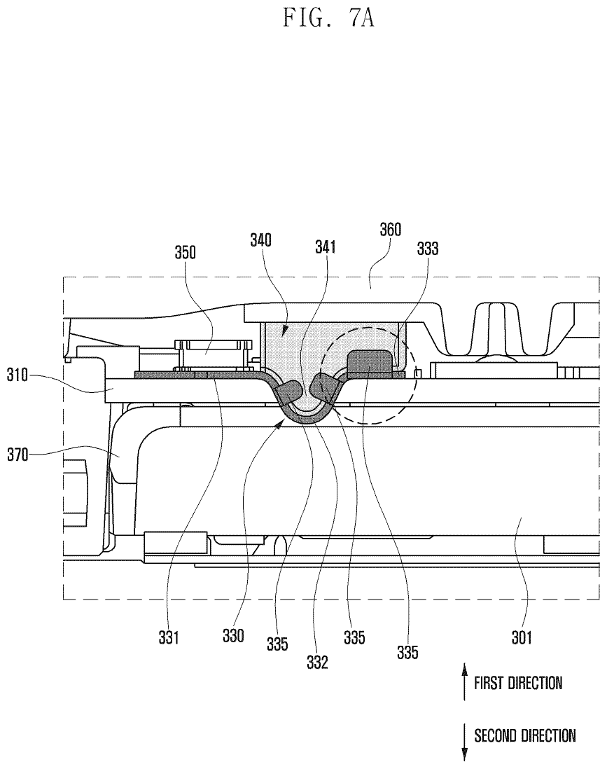

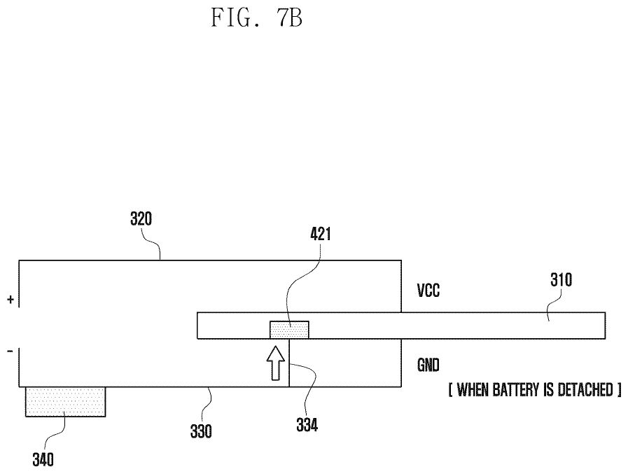

An electronic device 300 (e.g., the electronic device 101 of FIG. 1 and/or the electronic device 101 of FIG. 2) according to an embodiment may include a battery 301 (e.g., the battery 189 of FIG. 1) that supplies power to various electronic components (e.g., a processor (e.g., the processor 120 of FIG. 1), a memory (e.g., the memory 130 of FIG. 1), or a display (e.g., the display module 160 in FIG. 1)) included in the electronic device 300. In an embodiment, the battery 301 may be a battery detachable from the electronic device 300. For example, referring to FIG. 6A and FIG. 7A, which will be described later, the battery 301 may be mounted to a battery bracket 370 and electrically connected to a printed circuit board 310, or may be spaced apart from the battery bracket 370 and electrically disconnected from the printed circuit board 310.

In an embodiment, the battery 301 may be a lithium-ion (Li-ion) battery. The lithium-ion battery 301 has high energy density, excellent preservability, and a long life cycle, and may thus be used for a mobile electronic device. In some aspects, the battery 301 may be a lithium-ion polymer battery using a solid or gel-type electrolyte, and thus having a significantly low possibility of electrolyte material leakage. The battery 301 may be a lithium-ion battery with a large energy storage capacity per volume, but is not limited thereto.

In an embodiment, referring to FIG. 3A, the electronic device 300 may be supplied with power from the battery 301 in a state in which the battery 301 is electrically connected to a positive terminal 320 and a negative terminal 330 disposed on the printed circuit board 310. In an embodiment, the electronic device 300 may include a plurality of printed circuit boards, and the printed circuit board 310 described herein may be a printed circuit board 310 that is electrically connected to the battery 301. In an embodiment, the printed circuit board 310 may be fixed to a housing 360 in which an electronic component is disposed. For example, the printed circuit board 310 may be fixed to the housing 360 through a fixing member (e.g., a screw) inserted into a mount hole 312.

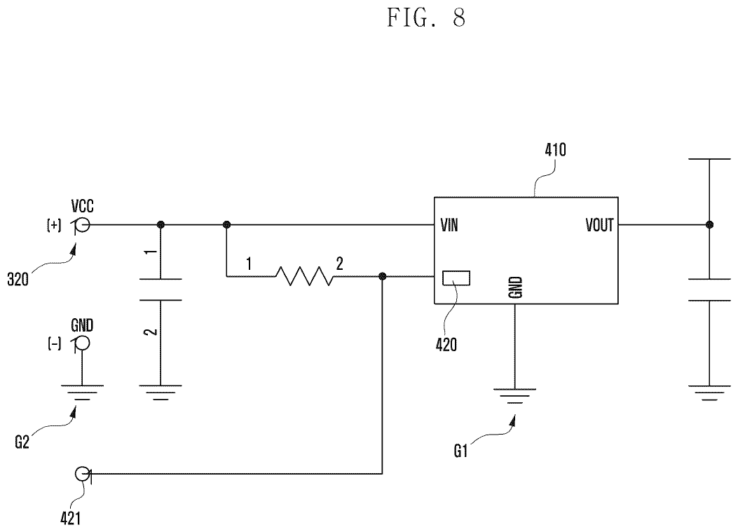

In an embodiment, referring to FIG. 8, which will be described later, a switch circuit unit 410 and a control circuit unit 420 may be disposed on the printed circuit board 310. The switch circuit unit 410 may supply power from the battery 301 to the electronic device 300 or block the power from being supplied to the electronic device 300. The control circuit unit 420 may connect or disconnect an input portion V_{In} and an output portion V_{Out} of the switch circuit unit 410 based on a voltage applied to the switch circuit unit 410. In an embodiment, in an example in which the input portion V_{In} and the output portion V_{Out} of the switch circuit unit 410 are connected in a circuit manner (e.g., are electrically coupled by one or more electrical components of the switch circuit unit 410, for example, by a first switch SW1 later described herein), the electronic device 300 may receive power from the battery 301. A power signal may be battery power applied to the electronic device 300. In an embodiment, in an example in which the input portion V_{In} and the output portion V_{Out} of the switch circuit unit 410 are electrically disconnected in a circuit manner, power supply from the battery 301 to the electronic device 300 may be blocked.

In an embodiment, referring to FIG. 6B and FIG. 7B, which will be described later, the control circuit unit 420 may include a contact terminal 421 that is in contact with a portion (e.g., a control pin 334) of the negative terminal 330. In an embodiment, the contact terminal 421 may include a plating layer on the printed circuit board 310, and the contact terminal 421 may be a portion that is in contact with the control pin 334 of the negative terminal 330. As will be described later, the contact terminal 421 of the control circuit unit 420 may be physically in contact with or spaced apart from the control pin 334 of the negative terminal 330 based on whether the battery 301 is mounted in the electronic device 300. Accordingly, for example, a voltage of the battery 301 input to the input portion V_{In} of the switch circuit unit 410 may change based on whether the control pin 334 and the contact terminal 421 are in contact. The control circuit unit 420 may be configured to detect changes in the voltage of the input portion V_{In}. In some aspects, the control circuit unit 420 may electrically connect or electrically disconnect the input portion V_{In} and the output portion V_{Out} based on detecting a change in the voltage of the input portion V_{In}, which will be described in detail later.

In an embodiment, the printed circuit board 310 may include a sensing circuit (not illustrated) capable of measuring a state of the battery 301, such as, for example, a lifespan of the battery 301, a discharge time (e.g., an amount of time until the battery 301 is fully discharged), the number of charges and discharges, lifespan prediction, and a resistance of the battery 301. The sensing circuit may be called, for example, a fuel gauge.

According to an embodiment, as illustrated in FIG. 3A and FIG. 3B, the electronic device 300 may include the positive terminal 320 and the negative terminal 330 that are formed of a conductive material and connect the printed circuit board 310 and the battery 301. In an embodiment, the positive terminal 320 may be inserted into a positive terminal insertion portion 313 formed on the printed circuit board 310 and electrically connect a positive electrode (+) of the battery 301 and the printed circuit board 310. The negative terminal 330 may be inserted into a negative terminal insertion portion 314 formed on the printed circuit board 310 and electrically connect a negative electrode (−) of the battery 301 and the printed circuit board 310. In an embodiment, the negative terminal 330 may be connected to a ground (e.g., a second ground G2 of FIG. 8) disposed on the printed circuit board 310. The battery 301 may supply power to the printed circuit board 310 through the positive terminal 320 and the negative terminal 330.

In an embodiment, referring to FIG. 3B, the printed circuit board 310 may include an opening 311 in which at least a portion (e.g., a negative electrode contact portion 332) of the negative terminal 330 is located. As will be described later, the negative terminal 330 may include the negative electrode contact portion 332 that is in contact with the negative electrode of the battery 301. In an embodiment, the negative electrode contact portion 332 may be inserted into the opening 311 of the printed circuit board 310 and be in contact with the negative electrode of the battery 301.

In an embodiment, referring to FIG. 3A and FIG. 3B, a contact member 350 may be disposed on the printed circuit board 310. In an embodiment, the contact member 350 may be a component that electrically connects the printed circuit board 310 and an electronic component. In an embodiment, the contact member 350 may be a clip (e.g., a c-clip) that is compressed when coming into contact with the electronic component.

According to an embodiment, as illustrated in FIG. 4, FIG. 5A, and FIG. 5B, the negative terminal 330 may include a connecting portion 331, the negative electrode contact portion 332, a body portion 333, a control pin 334, and a fixing portion 335. The foregoing components are for illustration, and at least one component may be omitted, or at least one other configuration may be added. In an embodiment, the connecting portion 331 may be inserted into the negative terminal insertion portion 314 of the printed circuit board 310 and be electrically connected to the ground (e.g., the second ground (G2) of FIG. 8) of the printed circuit board 310. In an embodiment, the negative electrode contact portion 332 may be located in the opening 311 of the printed circuit board 310 and be in contact with the negative electrode of the battery 301. In an embodiment, the negative electrode contact portion 332 may be formed in a shape which is bent with respect to the connecting portion 331 and/or the body portion 333, and the negative electrode contact portion 332 may be located at least partly in the opening 311 of the printed circuit board 310. In an embodiment, the body portion 333 may extend from the negative electrode contact portion 332 and face the contact terminal 421 of the control circuit unit 420. In an embodiment, the control pin 334 may be formed such that the control pin 334 protrudes from the body portion 333 in one direction.

In an embodiment, the negative terminal 330 is formed of a conductive metallic material and may be formed of a material having a certain level of elasticity. In an embodiment, the negative terminal 330 may elastically move based on whether being in contact with the battery 301.

According to an embodiment, as illustrated in FIG. 4, the negative terminal 330 and a buffering member 340 may be sequentially assembled on the printed circuit board 310.

In an embodiment, referring to FIG. 5A, the electronic device 300 may omit the buffering member 340. In an embodiment, as the battery 301 is mounted in the electronic device 300, the negative electrode contact portion 332 may be in contact with the negative electrode of the battery 301 and be pressed in a direction (e.g., a first direction of FIG. 6A) away from or distant from (e.g., by a predetermined distance amount) the printed circuit board 310. The connecting portion 331 of the negative terminal 330 may move in the first direction with respect to the printed circuit board 310 as the negative electrode contact portion 332 is pressed in the first direction, and based on the movement, the connecting portion 331 may be in a state of the connecting portion 331 being partly fixed to the negative terminal insertion portion 314. Further, the body portion 333 of the negative terminal 330 may be spaced apart from the contact terminal 421 of the control circuit unit 420 in the first direction as the negative electrode contact portion 332 is pressed in the first direction. Accordingly, for example, the control pin 334 formed in the body portion 333 may be spaced apart from the contact terminal 421 of the control circuit unit 420 in the first direction.

In an embodiment, referring to FIG. 7A, as the battery 301 is detached from the electronic device 300, the negative electrode contact portion 332 may move in a direction (e.g., a second direction) close to the printed circuit board 310 due to the elastic restoring force of the connecting portion 331. Accordingly, for example, the body portion 333 of the negative terminal 330 may move in a direction adjacent to the contact terminal 421 of the control circuit unit 420. Thus, based on the movement of the body portion 333, the control pin 334 formed on the body portion 333 and the contact terminal 421 of the control circuit unit 420 may be in contact.

In an embodiment, referring to FIG. 4, FIG. 5B, FIG. 6A, and FIG. 7A, the buffering member 340 may be disposed between the negative terminal 330 and the housing 360. The buffering member 340 may move along with the negative terminal 330 based on whether the battery 301 is mounted. In an embodiment, the buffering member 340 may be pressed or be compressed in the first direction (e.g., the first direction of FIG. 6A) as the battery 301 is mounted in the electronic device 300, which may press the negative electrode contact portion 332 in the first direction. The connecting portion 331 of the negative terminal 330 may move in the first direction with respect to the printed circuit board 310 as the negative electrode contact portion 332 is pressed in the first direction, and based on the movement, the connecting portion 331 may be in the state of the connecting portion 331 being partly fixed to the negative terminal insertion portion 314. Further, the body portion 333 of the negative terminal 330 may be spaced apart from the contact terminal 421 of the control circuit unit 420 in the first direction as the negative electrode contact portion 332 is pressed in the first direction. Accordingly, for example, the control pin 334 formed in the body portion 333 may be spaced apart from the contact terminal 421 of the control circuit unit 420 in the first direction.

Subsequently, the buffering member 340 may be restored in the second direction (e.g., a second direction of FIG. 7A) through an elastic restoring force of the buffering member 340, in a state in which the battery 301 is detached from the electronic device 300 and spaced apart from the negative electrode contact portion 332. The negative electrode contact portion 332 may move in the second direction through the elastic restoring force of the connecting portion 331 and the elastic restoring force of the buffering member 340. Accordingly, for example, the body portion 333 of the negative terminal 330 may be pressed in the second direction through the buffering member 340, and the control pin 334 may be in contact with the contact terminal 421 of the control circuit unit 420.

According to an embodiment, as illustrated in FIG. 5B, the buffering member 340 may be formed such that a shape of the buffering member 340 corresponds to at least a portion of the negative terminal 330. For example, the negative terminal 330 may include a protrusion 341 disposed on the negative electrode contact portion 332. In an embodiment, the buffering member 340 may be fixed to the negative terminal 330. For example, the buffering member 340 may be fixed to the negative terminal 330 through the fixing portion 335 formed on the negative terminal 330. In some aspects, the buffering member 340 may be fixed to the negative terminal 330 through an adhesive member (e.g., bonding or tape).

In an embodiment, the buffering member 340 may be formed of an elastic material. For example, the buffering member 340 may be formed of a material such as, for example, rubber, silicon, and/or urethane.

Although the connecting portion 331, the negative electrode contact portion 332, the body portion 333, the control pin 334, and the fixing portion 335 of the negative terminal 330 have been separately described for convenience of explanation, embodiments of the disclosure are not limited thereto. For example, the foregoing components are not physically separate components and may be formed in an integrated manner.

Further, in the descriptions herein, as illustrated in FIG. 5A, in a state where the electronic device 300 does not include the buffering member 340, the negative terminal 330 may move in a direction close to or distant from the printed circuit board 310 based on whether the battery 301 is mounted in the electronic device 300, and thus the control pin 334 may be in contact with or spaced apart from the contact terminal 421 of the control circuit unit 420. In some aspects, as illustrated in FIG. 5B, in a state where the electronic device 300 includes the buffering member 340, the negative terminal 330 may move in the direction close to or distant from the printed circuit board 310 through an elastic restoring force of the negative terminal 330 and the elastic restoring force of the buffering member 340 based on whether the battery 301 is mounted in the electronic device 300, and based on the movement of the negative terminal 330, the control pin 334 may be in contact with or spaced apart from the contact terminal 421 of the control circuit unit 420. For convenience of explanation, the following description is made assuming that the electronic device 300 includes the buffering member 340. However, the following description may be equally applied to a case where the electronic device 300 does not include the buffering member 340.

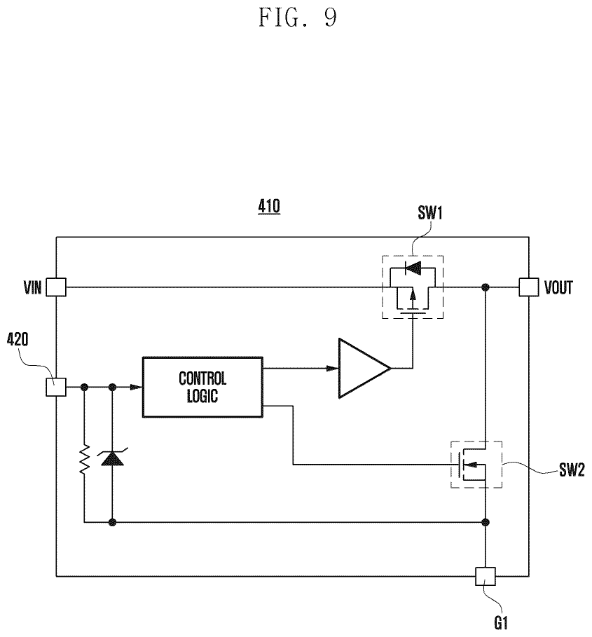

FIG. 6A is a view illustrating a state in which a control pin is spaced apart from a contact terminal of a control circuit unit of a printed circuit board as a negative electrode contact portion of a negative terminal comes in contact with a negative electrode of a battery in a state in which the battery is mounted in an electronic device according to an embodiment of the disclosure. FIG. 6B is a simplified view illustrating a circuit connection of the battery and the printed circuit board of FIG. 6A. FIG. 7A is a view illustrating a state in which a control pin of a negative terminal is in contact with a contact terminal of a control circuit unit of a printed circuit board in a state in which a battery is detached from an electronic device according to an embodiment of the disclosure. FIG. 7B is a simplified view illustrating a circuit connection of the battery and the printed circuit board of FIG. 7A. FIG. 8 is a view illustrating a circuit configuration of a power input unit according to an embodiment of the disclosure. FIG. 9 is a view illustrating a circuit configuration of a switch circuit unit according to an embodiment of the disclosure.

In an embodiment, referring to FIG. 6A and FIG. 6B, in an example in which a battery 301 (e.g., the battery 189 of FIG. 1) is mounted in an electronic device 300 (e.g., the electronic device 101 of FIG. 1 and/or the electronic device 101 of FIG. 2), a control pin 334 may be spaced apart from a contact terminal 421 of a control circuit unit 420 in a first direction (e.g., the first direction of FIG. 6A) in a state in which a negative electrode of the battery 301 is in contact with a negative electrode contact portion 332 (e.g., a state in which the battery 301 is mounted in the electronic device 300). For example, as the battery 301 is mounted in the electronic device 300, the negative electrode contact portion 332 of a negative terminal 330 may come into contact with the negative electrode of the battery 301 and be pressed in the first direction (e.g., the first direction of FIG. 6A) by the battery 301. Accordingly, for example, a body portion 333 connected to the negative electrode contact portion 332 may be spaced apart from the contact terminal 421 of the control circuit unit 420 in the first direction. Further, a buffering member 340 may be compressed or be pressed in the first direction as the battery 301 is mounted in the electronic device 300, which may press the negative electrode contact portion 332 in the first direction. Accordingly, for example, a control pin 334 formed in the body portion 333 may be spaced apart from the contact terminal 421 of the control circuit unit 420 in the first direction.

In an embodiment, referring to FIG. 7A and FIG. 7B, in a state in which the battery 301 is detached from the electronic device 300, the buffering member 340 may be restored in a second direction (e.g., the second direction of FIG. 7A) due to elastic restoring force. The negative electrode contact portion 332 may move in the second direction due to the elastic restoring force of a connecting portion 331 and the elastic restoring force of the buffering member 340. Accordingly, for example, the body portion 333 of the negative terminal 330 may be moved in the second direction due to movement of the buffering member 340 (e.g., the restoring of the buffering member 340 in the second direction), and the control pin 334 may come into contact with the contact terminal 421 of the control circuit unit 420.

In an embodiment, whether the contact terminal 421 of the control circuit unit 420 and the control pin 334 come into contact may be based on whether the battery 301 is mounted in the electronic device 300. In an embodiment, the control circuit unit 420 may connect or disconnect an input portion V_{In} and an output portion V_{Out} of a switch circuit unit 410 based on whether the contact terminal 421 of the control circuit unit 420 and the control pin 334 come into contact. For example, the control circuit unit 420 may connect or disconnect the input portion V_{In} and the output portion V_{Out} of a switch circuit unit 410 in response to determining whether the contact terminal 421 of the control circuit unit 420 and the control pin 334 come into contact.

In an embodiment, referring to FIG. 8, the control circuit unit 420 may be connected to the switch circuit unit 410 in a circuit manner. In an embodiment, the control circuit unit 420 may be connected to a positive terminal 320 through a resistor. In an embodiment, as illustrated in FIG. 6A and FIG. 6B, in the state in which the battery 301 is mounted in the electronic device 300, a power signal of the battery 301 may be applied to the control circuit unit 420 through the resistor, and may be applied to the input portion V_{In} of the switch circuit unit 410.

In an embodiment, referring to FIG. 8, the control circuit unit 420 may control a circuit connection or disconnection between the input portion V_{In} and the output portion V_{Out} of the switch circuit unit 410 (e.g., establish or block a circuit connection) based on comparing a voltage value applied to the input portion V_{In} of the switch circuit unit 410 with a threshold value depending on whether the battery 301 is mounted in the electronic device 300. In an embodiment, the control circuit unit 420 may control a first switch SW1 in association with connecting or disconnecting the input portion V_{In} and the output portion V_{Out} of the switch circuit unit 410.

In an embodiment, referring to FIG. 6A, FIG. 6B, FIG. 8, and FIG. 9, the contact terminal 421 of the control circuit unit 420 may be spaced apart from the control pin 334 of the negative terminal 330 in the state in which the battery 301 is mounted in the electronic device 300. The control circuit unit 420 may identify the voltage value of the power signal of the battery 301 input to the input portion V_{In} of the switch circuit unit 410. In an embodiment, the control circuit unit 420 may compare the voltage value input to the input portion V_{In} of the switch circuit unit 410 with the preset threshold value in association with determining whether the voltage value input to the input portion V_{In} is greater than the threshold value.

In an example, the control circuit unit 420 may detect that the voltage value applied to the input portion V_{In} of the switch circuit unit 410 is greater than the threshold value (high state). In this case, the control circuit unit 420 may transmit a switch control signal to the first switch SW1 to connect a circuit of the input portion V_{In} and the output portion V_{Out} (expressed another way, to establish an electrical connection between the input portion V_{In} and the output portion V_{Out} via the first switch SW1). Accordingly, for example, the power signal of the battery 301 applied to the input portion V_{In} of the switch circuit unit 410 may be transmitted to the output portion V_{Out} of the switch circuit unit 410, thus supplying power to the electronic device 300. In addition, in response to detecting that the voltage value applied to the input portion V_{In} of the switch circuit unit 410 is greater than the threshold value (high state), the control circuit unit 420 may transmit a switch control signal to a second switch SW2 that blocks a circuit connection between the output portion V_{Out} of the switch circuit unit 410 and a first ground G1 (expressed another way, to prevent an electrical connection between the output portion V_{Out} and the first ground G1). Accordingly, embodiments of the present disclosure include preventing the power signal of the battery 301 applied from the input portion V_{In} to the output portion V_{Out} from being discharged to the first ground G1.

In an embodiment, referring to FIG. 7A, FIG. 7B, FIG. 8, and FIG. 9, in an example in which the battery 301 is detached from the electronic device 300, the contact terminal 421 of the control circuit unit 420 may be in contact with the control pin 334 of the negative terminal 330. The contact terminal 421 may be electrically connected to a second ground G2 through the control pin 334 as the negative terminal 330 is electrically connected to the second ground G2 of the printed circuit board 310. In this case, the power signal of the battery 301 applied to the switch circuit unit 410 may be discharged to the second ground G2 through the control pin 334. Further, as the battery 301 is detached from the electronic device 300, power may not be supplied to the input portion V_{In} of the switch circuit unit 410. Accordingly, for example, the voltage value of the battery 301 applied to the input portion V_{In} of the switch circuit unit 410 may be reduced.

In an embodiment, in an example in which the control circuit unit 420 compares the voltage value input to the input portion V_{In} of the switch circuit unit 410 with the preset threshold value and detects that the voltage value input to the input portion V_{In} is less than the threshold value (low state), the control circuit unit 420 may transmit a switch control signal to the first switch SW1 to block the circuit connection between the input portion V_{In} and the output portion V_{Out} (expressed another way, to prevent an electrical connection between the input portion V_{In} and the output portion V_{Out}). Accordingly, embodiments of the present disclosure include preventing the power signal of the battery 301 remaining in the input portion V_{In} of the switch circuit unit 410 from being transmitted to the output portion V_{Out} of the switch circuit unit 410, thereby blocking supply of power to the electronic device 300. Further, the control circuit unit 420 may transmit a switch control signal to the second switch SW2 in association with connecting a circuit of the output portion V_{Out} of the switch circuit unit 410 and the first ground G1 (expressed another way, to establish an electrical connection between the output portion V_{Out} and the first ground G1 via the second switch SW2). In the state in which the battery 301 is detached from the electronic device 300, as the output portion V_{Out} of the switch circuit unit 410 and the first ground G1 are connected in a circuit, a remaining current of the switch circuit unit 410 may be discharged to the first ground G1. Accordingly, for example, the electronic device 300 may be powered off.

According to an embodiment of the disclosure, in an example in which the battery 301 is detached, remaining power of the electronic device 300 may be consumed more rapidly, for example, compared to a power consumption rate of the electronic device 300 in a state in which the battery 301 is mounted in the electronic device 300. For example, based on detection of a voltage value of a certain level or less in the control circuit unit 420 connected to the switch circuit unit 410 that supplies or blocks power of the battery 301, the circuit (e.g., including the first switch SW1) connecting the input portion V_{In} and the output portion V_{Out} of the switch circuit unit 410 may be blocked and the output portion V_{Out} of the switch circuit unit 410 and the first ground may be connected through the circuit including the second switch SW2. Accordingly, in an example in which the battery 301 is detached, the electronic device 300 may be powered off, which may prevent the electronic device 300 from performing an unintended operation. For example, in the state in which the battery 301 is detached, the electronic device 300 may refrain from performing unintended operations.

In some aspects, as the remaining power in the electronic device 300 is consumed more rapidly in the state in which the battery 301 is detached, the electronic device 300 may quickly recognize whether a new battery is mounted when the new battery 301 is mounted. For example, in an example in which the new battery 301 is mounted, the control circuit unit 420 may control the first switch SW1 to connect the circuit of the input portion V_{In} and the output portion V_{Out} of the switch circuit unit 410 and to supply power from the battery 301 to the electronic device 300 based on detecting the voltage value of the battery 301 applied to the input portion V_{In} of the switch circuit unit 410 exceeds the threshold value.

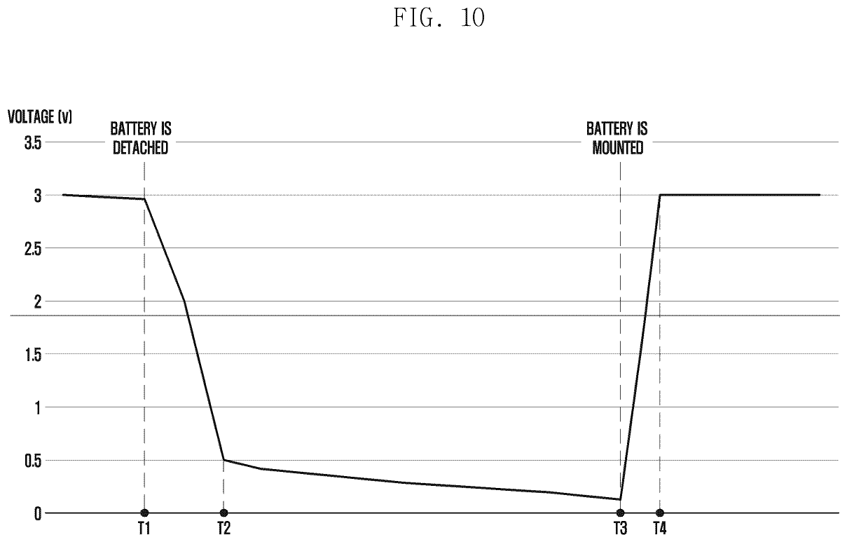

FIG. 10 is a view illustrating voltage changes at an electronic device when a battery is detached from or mounted in the electronic device according to an embodiment of the disclosure.

According to an embodiment, FIG. 10 is a graph illustrating voltage with respect to time in association with detaching a battery 301 (e.g., the battery 189 of FIG. 1) from an electronic device 300 (e.g., the electronic device 101 of FIG. 1 and/or the electronic device 101 of FIG. 2) and mounting the battery 301 to the electronic device 300. FIG. 10 illustrates an amount of time over which the electronic device 300 consumes remaining power in the electronic device 300 when the battery 301 is detached from the electronic device 300 and an amount of time over which power from the battery 301 is applied to the electronic device 300 when the battery 301 is mounted in the electronic device 300.

In an embodiment, referring to FIG. 10, a voltage at an output portion V_{Out} of a switch circuit unit 410 may be 3 V at a time point T1 when the battery 301 is detached, and the voltage may drop to 0.5 V at a time point T2. For example, as described herein, as a control circuit unit 420 connects the output portion V_{Out} of the switch circuit unit 410 and a first ground G1 through the second switch SW2, when the battery 301 is detached, the voltage of the output portion V_{Out} may drop from 3 V to 0.5V over a time period from time point T1 to time point T2 (in which the time period is equal to time point T2 minus time point T1) after the battery 301 is detached. In an embodiment, the time period of time point T2 minus time point T1 may be approximately 2 seconds. Accordingly, for example, the electronic device 300 may be in a power-off state when the battery 301 is detached. Subsequently, as a new battery 301 is mounted in the electronic device 300 at a time point T3, the voltage of the output portion V_{Out} of the switch circuit unit 410 may be measured as 3 V at a time point T4. In an embodiment, the time period of time point T4 minus time point T3 may be approximately 2 seconds. Compared to other approaches, remaining power in the electronic device 300 is consumed within a shorter time (e.g., about 2 seconds) when the battery 301 is detached, and the electronic device 300 may recognize within a shorter time (e.g., about 2 seconds) whether a new battery 301 is mounted when the new battery 301 is mounted.

An electronic device 300 (e.g., the electronic device 101 of FIG. 1 and/or the electronic device 101 of FIG. 2) according to an embodiment of the disclosure may include a printed circuit board 310 including an opening 311. Further, the electronic device may include a switch circuit unit 410 disposed on the printed circuit board and including an input portion V_{In} to which a power signal of a battery 301 (e.g., the battery 189 of FIG. 1) is applied, an output portion V_{Out} from which the switch circuit unit 410 is configured to output the power signal, and a first ground G1. Further, the electronic device may include a control circuit unit 420 disposed on the printed circuit board, wherein the control circuit unit 420 is configured to control a connection between the input portion and the output portion and includes a contact terminal 421. Further, the electronic device may include a positive terminal 320 connected to the printed circuit board to transmit the power signal of the battery. Further, the electronic device may include a negative terminal 330 including a body portion 333 which faces the contact terminal of the control circuit unit, a control pin 334 formed on the body portion 333, and a negative electrode contact portion 332 which is at least partly located in the opening and configured to contact a negative electrode of the battery, wherein the negative electrode contact portion is connected to a second ground G2 of the printed circuit board.

The control pin of the negative terminal may be spaced apart from the contact terminal of the control circuit unit in a state in which the negative electrode contact portion is in contact with the negative electrode of the battery. Further, the control pin of the negative terminal may be in contact with the contact terminal of the control circuit unit in a state in which the negative electrode contact portion is spaced apart from the negative electrode of the battery.

The control circuit unit may identify a voltage value of the power signal applied to the input portion of the switch circuit unit in a state in which the positive terminal and the negative terminal are connected to the battery. Further, the control circuit unit may electrically connect the input portion and the output portion by controlling a first switch and may block an electrical circuit connection between the output portion and the first ground by controlling a second switch, based on the voltage value being greater than a threshold value.

The power signal applied to the switch circuit unit may be discharged to the second ground through the control pin in the state in which the negative electrode contact portion is spaced apart from the negative electrode of the battery.

The control circuit unit may identify a voltage value of the power signal applied to the input portion of the switch circuit unit. Further, the control circuit unit may block an electrical circuit connection between the input portion and the output portion by controlling a first switch and may electrically connect the output portion and the first ground by controlling a second switch, based on the voltage value being less than a threshold value.

The electronic device may include a housing 360 on which the printed circuit board is disposed. Further, the electronic device may include a buffering member 340 disposed between the housing and the negative terminal and formed of an elastic material.

The buffering member may be fixed to the negative terminal.

The negative terminal may include a fixing portion 335 extending in one direction and fixing the buffering member to the negative terminal.

The negative terminal may include a connecting portion 331 connected to the second ground of the printed circuit board. The negative electrode contact portion may be formed in a shape which is bent with respect to the connecting portion.

The buffering member may include a protrusion 341 formed such that a shape of the protrusion 341 corresponds to the negative electrode contact portion, and the protrusion 341 may be fixed to the negative electrode contact portion.

A battery structure according to an embodiment of the disclosure may include a printed circuit board 310 including an opening 311. Further, the battery structure may include a switch circuit unit 410 disposed on the printed circuit board and including an input portion Vᵢₙ to which a power signal of a battery 301 (e.g., the battery 189 of FIG. 1) is applied, an output portion V_{Out} from which the switch circuit unit 410 is configured to output the power signal, and a first ground G1. Further, the battery structure may include a control circuit unit 420 disposed on the printed circuit board, wherein the control circuit unit 420 is configured to control a connection between the input portion and the output portion and includes a contact terminal 421. Further, the battery structure may include a positive terminal 320 connected to the printed circuit board to transmit the power signal of the battery. Further, the battery structure may include a negative terminal 330 including a body portion 333 which faces the contact terminal of the control circuit unit, a control pin 334 formed on the body portion 333, and a negative electrode contact portion 332 which is at least partly located in the opening and configured to contact a negative electrode of the battery, wherein the negative electrode contact portion is connected to a second ground G2 of the printed circuit board.

The control pin of the negative terminal may be spaced apart from the contact terminal of the control circuit unit in a state in which the negative electrode contact portion is in contact with the negative electrode of the battery. Further, the control pin of the negative terminal may be in contact with the contact terminal of the control circuit unit in a state in which the negative electrode contact portion is spaced apart from the negative electrode of the battery.

The control circuit unit may identify a voltage value of the power signal applied to the input portion of the switch circuit unit in a state in which the positive terminal and the negative terminal are connected to the battery. Further, the control circuit unit may electrically connect the input portion and the output portion by controlling a first switch and may block an electrical circuit connection between the output portion and the first ground by controlling a second switch, based on the voltage value being greater than a threshold value.

The power signal applied to the switch circuit unit may be discharged to the second ground through the control pin in the state in which the negative electrode contact portion is spaced apart from the negative electrode of the battery.

The control circuit unit may identify a voltage value of the power signal applied to the input portion of the switch circuit unit. Further, the control circuit unit may block an electrical circuit connection between the input portion and the output portion by controlling a first switch and may electrically connect the output portion and the first ground by controlling a second switch, based on the voltage value being less than a threshold value.

The electronic device may include a housing 360 on which the printed circuit board is disposed. Further, the electronic device may include a buffering member 340 disposed between the housing and the negative terminal and formed of an elastic material.

The buffering member may be fixed to the negative terminal.

The negative terminal may include a fixing portion 335 extending in one direction and fixing the buffering member to the negative terminal.

The negative terminal may include a connecting portion 331 connected to the second ground of the printed circuit board. The negative electrode contact portion may be formed in a shape which is bent with respect to the connecting portion.

The buffering member may include a protrusion 341 formed such that a shape of the protrusion 341 corresponds to the negative electrode contact portion, and the protrusion 341 may be fixed to the negative electrode contact portion.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to the electronic devices described herein.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), the description means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part of the single integrated component. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more stored instructions from the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as, for example, memory of the manufacturer's server, a server of the application store, or a relay server.

According to various embodiments, each element (e.g., a module or a program) of the elements described herein may include a single entity or multiple entities, and some of the multiple entities may be separately disposed in any other element. According to various embodiments, one or more of the elements described herein may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

It will be understood that embodiments based on combinations of any two or more of the embodiments disclosed herein and embodiments including any combination of the foregoing features are considered and included in the disclosure in addition to the embodiments disclosed herein. That is, the absence of an explicit indication that two features may be combined or two embodiments may be combined does not mean that such combinations are not considered, but should be construed as including such combinations herein.

What is claimed is:

1. An electronic device comprising:
a printed circuit board comprising an opening;
a switch circuit unit disposed on the printed circuit board and comprising:
an input portion to which a power signal of a battery is applied;
an output portion from which the switch circuit unit is configured to output the power signal; and
a first ground;
a control circuit unit disposed on the printed circuit board, wherein the control circuit unit is configured to control a connection between the input portion and the output portion and comprises a contact terminal;
a positive terminal configured to connect the printed circuit board and a positive electrode of the battery; and
a negative terminal comprising:
a body portion which faces the contact terminal of the control circuit unit;
a control pin formed on the body portion; and
a negative electrode contact portion which is at least partly located in the opening and configured to contact a negative electrode of the battery, wherein the negative electrode contact portion is connected to a second ground of the printed circuit board.

2. The electronic device of claim 1, wherein:
the control pin of the negative terminal is spaced apart from the contact terminal of the control circuit unit in a state in which the negative electrode contact portion is in contact with the negative electrode of the battery, and
the control pin of the negative terminal is in contact with the contact terminal of the control circuit unit in a state in which the negative electrode contact portion is spaced apart from the negative electrode of the battery.

3. The electronic device of claim 1, wherein the control circuit unit is configured to:
identify a voltage value of the power signal applied to the input portion of the switch circuit unit in a state in which the positive terminal and the negative terminal are connected to the battery; and
electrically connect the input portion and the output portion by controlling a first switch and block an electrical circuit connection between the output portion and the first ground by controlling a second switch, based on the voltage value being greater than a threshold value.

4. The electronic device of claim 2, wherein the power signal applied to the switch circuit unit is discharged to the second ground through the control pin in the state in which the negative electrode contact portion is spaced apart from the negative electrode of the battery.

5. The electronic device of claim 1, wherein the control circuit unit is configured to:
identify a voltage value of the power signal applied to the input portion of the switch circuit unit; and
block an electrical circuit connection between the input portion and the output portion by controlling a first switch and electrically connect the output portion and the first ground by controlling a second switch, based on the voltage value being less than a threshold value.

6. The electronic device of claim 1, further comprising:
a housing on which the printed circuit board is disposed; and
a buffering member disposed between the housing and the negative terminal and formed of an elastic material.

7. The electronic device of claim 6, wherein the buffering member is fixed to the negative terminal.

8. The electronic device of claim 7, wherein the negative terminal comprises a fixing portion extending in one direction and fixing the buffering member to the negative terminal.

9. The electronic device of claim 1, wherein the negative terminal comprises a connecting portion connected to the second ground of the printed circuit board, and
wherein the negative electrode contact portion is formed in a shape which is bent with respect to the connecting portion.

10. The electronic device of claim 6, wherein the buffering member comprises a protrusion formed such that a shape of the protrusion corresponds to the negative electrode contact portion, and the protrusion is fixed to the negative electrode contact portion.

11. A battery structure comprising:
a printed circuit board comprising an opening;
a switch circuit unit disposed on the printed circuit board and comprising:
an input portion to which a power signal of a battery is applied;
an output portion from which the switch circuit unit is configured to output the power signal; and
a first ground;
a control circuit unit disposed on the printed circuit board, wherein the control circuit unit is configured to control a connection between the input portion and the output portion and comprises a contact terminal;
a positive terminal configured to connect the printed circuit board and a positive electrode of the battery; and
a negative terminal comprising:
a body portion which faces the contact terminal of the control circuit unit;
a control pin formed on the body portion; and
a negative electrode contact portion which is at least partly located in the opening and configured to contact a negative electrode of the battery, wherein the negative electrode contact portion is connected to a second ground of the printed circuit board.

12. The battery structure of claim 11, wherein:
the control pin of the negative terminal is spaced apart from the contact terminal of the control circuit unit in a state in which the negative electrode contact portion is in contact with the negative electrode of the battery, and
the control pin of the negative terminal is in contact with the contact terminal of the control circuit unit in a state in which the negative electrode contact portion is spaced apart from the negative electrode of the battery.

13. The battery structure of claim 11, wherein the control circuit unit is configured to:
identify a voltage value of the power signal applied to the input portion of the switch circuit unit in a state in which the positive terminal and the negative terminal are connected to the battery; and
electrically connect the input portion and the output portion by controlling a first switch and block an electrical circuit connection between the output portion and the first ground by controlling a second switch, based on the voltage value being greater than a threshold value.

14. The battery structure of claim 12, wherein the power signal applied to the switch circuit unit is discharged to the second ground through the control pin in the state in which the negative electrode contact portion is spaced apart from the negative electrode of the battery.

15. The battery structure of claim 11, wherein the control circuit unit is configured to:
identify a voltage value of the power signal applied to the input portion of the switch circuit unit; and
block an electrical circuit connection between the input portion and the output portion by controlling a first switch and electrically connect the output portion and the first ground by controlling a second switch, based on the voltage value being less than a threshold value.

16. The battery structure of claim 11, further comprising:
a housing on which the printed circuit board is disposed; and
a buffering member disposed between the housing and the negative terminal and formed of an elastic material.

17. The battery structure of claim 16, wherein the buffering member is fixed to the negative terminal.

18. The battery structure of claim 17, wherein the negative terminal comprises a fixing portion extending in one direction and fixing the buffering member to the negative terminal.

19. The battery structure of claim 11, wherein the negative terminal comprises a connecting portion connected to the second ground of the printed circuit board, and
wherein the negative electrode contact portion is formed in a shape which is bent with respect to the connecting portion.

20. The battery structure of claim 16, wherein the buffering member comprises a protrusion formed such that a shape of the protrusion corresponds to the negative electrode contact portion, and the protrusion is fixed to the negative electrode contact portion.
